(19) United States
(12) Patent Application Publication
(10) Pub. No.: US 2010/0018746 A1
(43) Pub. Date: Jan. 28, 2010

(54) MULTI CONDUCTOR CABLE FOR A PORTABLE ELECTRIC TOOL

(75) Inventor: Karl Johan Lars Elsmark, Saltsjo-Boo (SE)

Correspondence Address: FRISHAUF, HOLTZ, GOODMAN & CHICK, PC, 220 Fifth Avenue, 16TH Floor, NEW YORK, NY, 10001-7708, US

(73) Assignee: Atlas Copco Tools AB, Nacka (SE)

(21) Appl. No.: 12/443,862

(22) PCT Filed: Sep. 27, 2007
(86) PCT No.: PCT/SE07/00847

§ 371 Date: Apr. 1, 2009

(30) Foreign Application Priority Data
Oct. 2, 2006 (SE) 0602038-2

(51) Int. Cl. H01B 7/08; B32B 1/00

(52) U.S. Cl. 174/117 F; 264/171.13; 439/492

(57) ABSTRACT

A multi conductor flat type cable, which is intended for connecting a portable electric power tool to a stationary power supply and operation control unit, has a connector plug (18) attached to its one end, wherein the cable (10) has a twisted shape section (A) adjacent the connector plug (18) for facilitating universal bending of the cable (10). The twisted section (A) is provided with a transition sleeve (16) with a cylindrical portion (17) at the connector plug end and two tapering tongues (20, 21) extending along the cable (10) over at least a part of the twisted section (A), wherein the cable (10) is adapted to the cylindrical shape of the connector plug (18) and strengthened against too close bending in the twisted section (A). The transition sleeve (16) is moulded onto the cable (10) in a first manufacturing step, and in a second step the cable (10) together with the transition sleeve (16) are heated to a certain temperature and twisted to assume the twisted shape in the section (A).

The invention relates to a flat type multi conductor cable for connecting an electric power tool to a power supply and operation control unit. In particular the invention concerns a flat type multi conductor cable carrying at its one end a connector plug for connection to the power tool and comprising a twisted section for universal easy bending of the cable.

A power tool cable of the above type is previously described in U.S. Pat. No. 5,750,932. This cable is disadvantageous both in that it could be too closely bent adjacent the connector plug and thereby easily get damaged, and in that the flat shape in itself makes it difficult to get an acceptable connection with a standard type connector plug.

The object of the invention is on one hand to provide a flat type multi conductor cable with a universal bending support adjacent the connector plug and to adapt the shape of the cable to standard type connector plugs, and on the other hand to create a method for providing a flat type cable with both an external transition sleeve and a twisted section for universal easy bending of the cable.

Further characteristic features and advantages of the invention will appear from the following specification.

A preferred embodiment of the invention is below described in detail with reference to the accompanying drawing.

In the drawing

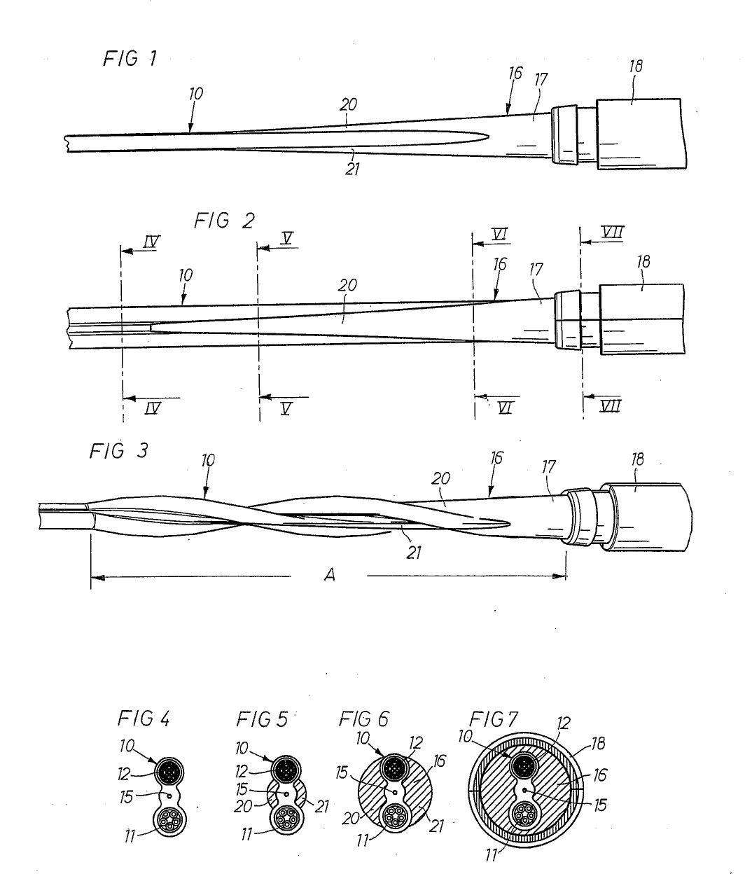

FIG. 1 shows a side view of a multi conductor cable according to the invention.

FIG. 2 shows a top view of the cable in FIG. 1.

FIG. 3 shows a perspective view of the cable in FIGS. 1 and 2 after having been subjected to twisting.

FIG. 4 shows a cross section along line IV-IV in FIG. 2.

FIG. 5 shows a cross section along line V-V in FIG. 2.

FIG. 6 shows a cross section along line VI-VI in FIG. 2.

FIG. 7 shows a cross section along line VII-VII in FIG. 2.

The cable illustrated in the drawing figures comprises a flat type of cable 10 for connecting a power tool to a remotely located control unit and includes one section 11 with coarse conductors for power supply to the power tool, and another section 12 with tinier conductors for transfer of electrical signals between the power tool and the control unit. Between the to conductor sections 11, 12 there is provided a mechanical pulling load transferring string 13 of for instance Kevlar. In order to facilitate a universal bending of the cable and improve handling of the power tool the cable is preformed to twisted form over a section A adjacent the power tool. This type of cable is previously described in U.S. Pat. No. 5,750,932.

The problems mentioned in the preamble of the specification regarding adaptation of the flat cable 10 to a standard type cylindrical connector plug 18 and also to avoid too close bending of the cable 10 and a risk for damaging the cable are solved by providing the cable 10 adjacent its power tool end with a flexible transition sleeve 16 which has a cylindrical section 17 close to the connector plug 18 and two parallel tapering tongues 20, 21 extending along the cable 10 away from the connector plug 16 over the twisted section A.

By the cross section shown in FIG. 7 it is illustrated how the full circular cross section of the transition sleeve 16 adapts the flat cable 10 to the cylindrical connector plug 18, and in FIGS. 6-4 it is illustrated how the tongues 20, 21 of the transition sleeve 16 successively taper to finally in FIG. 4 have ended and left the flat cable 10 in its original shape. The tongues 20, 21 provide a successively increasing strengthening effect towards bending of the cable 10 the closer they get to the connector plug 18.

In a first step of forming section A of the cable 10 the transition sleeve 16 is moulded onto the cable 10 as the latter is still in a straight untwisted shape, whereafter in a second step the section A of the cable 10 together with the transition sleeve 16 are heated to a certain temperature and exposed to a twisting force. When resuming normal temperature the section A of the cable 10 and the transition sleeve 16 assume a permanently twisted shape as illustrated in FIG. 3.

1-3. (canceled)

4. A multi conductor cable having a substantially flat shape and being intended for connecting a portable electric power tool to a power supply operation control unit, comprising:
a connector plug attached to one end of the cable for connecting the cable to the power tool;
a twisted section close to the connector plug for facilitating universal bending of the cable;
an external flexible transition sleeve connected to the cable adjacent to the connector plug end of the cable;
said transition sleeve having a length to extend over at least a part of the twisted section; and
said transition sleeve comprising a cylindrical section at the connector plug end of the cable and two parallel tongues which taper along the cable over at least a part of the twisted section.

5. The cable according to claim 4, wherein said transition sleeve is molded onto the originally flat cable.

6. A method for providing an originally flat multi conductor cable with an easily bendable twisted section, and an external flexible transition sleeve, as claimed in claim 4, comprising:
first step of molding said transition sleeve onto the cable; and
heating the cable and the transition sleeve to a certain temperature and together exposing them to a twisting force so as permanently form said twisted section.
